(19) United States
(12) Patent Application Publication
(10) Pub. No.: US 2017/0302844 A1
(43) Pub. Date: Oct. 19, 2017

(54) IMAGE CAPTURING APPARATUS, CONTROL METHOD THEREFOR, AND STORAGE MEDIUM

(71) Applicant: CANON KABUSHIKI KAISHA, Tokyo (JP)

(72) Inventors: Miyako Nakamoto, Tokyo (JP); Toshiyuki Watanabe, Kawasaki-shi (JP); Akira Karasawa, Kawasaki-shi (JP); Katsutoshi Horima, Yokohama-shi (JP); Akio Yoshida, Yokohama-shi (JP); Nobuhiro Fujinaga, Hadano-shi (JP)

(21) Appl. No.: 15/480,606

(22) Filed: Apr. 6, 2017

(30) Foreign Application Priority Data
Apr. 13, 2016 (JP) 2016-080472
Apr. 21, 2016 (JP) 2016-085428

(51) Int. Cl. H04N 5/232; H04N 5/262; G02B 7/34; H04N 5/372; G02B 7/28

(52) U.S. Cl. CPC H04N 5/23212; H04N 5/372; H04N 5/2628; H04N 5/23296; H04N 5/23258; G02B 7/343; G02B 7/28

(57) ABSTRACT

An image capturing apparatus includes: an image capturing unit; a focus detection unit that detects a focus position of an imaging optical system based on a phase-difference detection method; an imaging control unit that controls the image capturing unit to make the image capturing unit acquire pieces of light field data in one-to-one correspondence with a plurality of focus positions of the imaging optical system; and a generation unit that generates a refocused image corresponding to a focus position between the plurality of focus positions of the imaging optical system using the pieces of light field data, the generation depending on a direction of phase-difference detection by the focus detection unit and on a direction of parallax in the pieces of light field data.

### BACKGROUND OF THE INVENTION

### Field of the invention

The present invention relates to a technique for correcting an error in focus detection in an image capturing apparatus.

### Description of the Related Art

It is common that an image capturing apparatus equipped with an automatic focus adjustment apparatus capable of automatically focusing on an object has a function of causing a calibration apparatus to correct, if any, an error in a defocus amount calculated by the automatic focus adjustment apparatus.

Japanese Patent Laid-Open. No. 2005-109621 discloses an image capturing apparatus with a calibration mode for acquiring a correction value for an automatic focus adjustment apparatus. Images and defocus amounts are acquired at different focusing lens positions, and a user selects an image with a perfect focus from among the acquired images. Then, the defocus amount acquired at the same time as the selected image is stored as a correction value.

Meanwhile, an image capturing apparatus has been offered that divides an exit pupil of a photographing lens into a plurality of partial pupil areas, and hence can simultaneously shoot a plurality of parallax images corresponding to the partial pupil areas. U.S. Pat. No. 4,410,804 discloses an image capturing apparatus that includes a two-dimensional image sensor in which a photoelectric converter divided into a plurality of parts is disposed in correspondence with one microlens. Each photoelectric converter is configured in such a manner that its divided parts receive light from different partial pupil areas of an exit pupil of a photographing lens via one microlens. A plurality of parallax images corresponding to the partial pupil areas can be generated from image signals generated by photoelectrically converting object light received by the divided parts of each photoelectric converter.

Japanese Patent Laid-Open No. 2010-197551 offers an image capturing apparatus that performs bracket shooting while moving a focusing lens so as to expand a range in which a plurality of parallax images can be generated. The plurality of shot parallax images are equivalent to light field (LF) data, which is information of the spatial distribution of light intensity and the angle distribution, Stanford Tech. Report CTSR 2005-02, 1 (2005) discloses a refocusing technique for changing an in-focus position of a shot image, after shooting, by synthesizing an image on a virtual image-forming plane that is different from an imaging plane using acquired IF data.

The conventional technique disclosed in Japanese Patent Laid-Open No. 2005-109621 mentioned earlier needs to repeat a shooting operation while moving a lens so as to shoot a plurality of images on which a user can check the changed focus; therefore, shooting takes time.

### SUMMARY OF THE INVENTION

The present invention has been made in view of the foregoing problem, and makes it possible to easily acquire a plurality of images with different focuses in calibrating focus detection.

According to a first aspect of the present invention, there is provided an image capturing apparatus, comprising: an image capturing unit that photoelectrically converts an object image; a focus detection unit that detects a focus position of an imaging optical system based on a phase-difference detection method using a pair of image signals formed by light that has passed through different pupil areas of the imaging optical system; an imaging control unit that controls the image capturing unit to make the image capturing unit acquire pieces of light field data in one-to-one correspondence with a plurality of focus positions of the imaging optical system that are obtained by shifting the detected focus position of the imaging optical system in increments of a predetermined amount; and a generation unit that generates a refocused image corresponding to a focus position between the plurality of focus positions of the imaging optical system using the pieces of light field data, the generation depending on a direction of phase-difference detection by the focus detection unit and on a direction of parallax in the pieces of light field data.

According to a second aspect of the present invention, there is provided a method of controlling an image capturing apparatus including an image capturing unit that photoelectrically converts an object image, the method comprising: detecting a focus position of an imaging optical system based on a phase-difference detection method using a pair of image signals formed by light that has passed through different pupil areas of the imaging optical system; controlling the image capturing unit to make the image capturing unit acquire pieces of light field data in one-to-one correspondence with a plurality of focus positions of the imaging optical system that are obtained by shifting the detected focus position of the imaging optical system in increments of a predetermined amount; and generating a refocused image corresponding to a focus position between the plurality of focus positions of the imaging optical system using the pieces of light field data, the generating depending on a direction of phase-difference detection in the detecting and on a direction of parallax in the pieces of light field data.

According to a third aspect of the present invention, there is provided an image capturing apparatus, comprising: an image capturing unit capable of acquiring light field data; a generation unit that generates a refocused image by applying refocusing processing to the light field data acquired by the image capturing unit; an image processing unit that applies image processing to at least one of a shot image to which the refocusing processing based on the light field data has not been applied and the refocused image; a display unit that displays the shot image and the refocused image; and a control unit that, in a predetermined mode for causing the display unit to display a plurality of images including the shot image and the refocused image and allowing one of the plurality of images to be selected, controls the image processing unit to execute the image processing to reduce a difference between resolutions of the shot image and the refocused image displayed on the display unit.

According to a fourth aspect of the present invention, there is provided a method of controlling an image capturing apparatus including an image capturing unit capable of acquiring light field data, the method comprising: generating a refocused image by applying refocusing processing to the light field data acquired by the image capturing unit; applying image processing to at least one of a shot image to which the refocusing processing based on the light field data has not been applied and the refocused image; displaying the shot image and the refocused image on a display unit; and in a predetermined mode for causing the display unit to display a plurality of images including the shot image and the refocused image and allowing one of the plurality of images to be selected, controlling the applying of the image processing to reduce a difference between resolutions of the shot image and the refocused image displayed on the display unit.

Further features of the present invention will become apparent from the following description of exemplary embodiments with reference to the attached drawings.

### BRIEF DESCRIPTION OF THE DRAWINGS

FIG. 1 shows a schematic configuration of an image capturing apparatus according to a first embodiment.

FIGS. 2A and 2B are schematic diagrams showing the layout of focus detection areas in an area sensor according to the first embodiment.

FIG. 3 shows a pixel arrangement in an image sensor according to the first embodiment.

FIG. 4A is a schematic plan view of a pixel in the image sensor according to the first embodiment. FIG. 4B is a schematic cross-sectional view of a pixel in the image sensor according to the first embodiment.

FIG. 5 is a schematic diagram illustrating a pixel in the image sensor and pupil division according to the first embodiment.

FIG. 6 is a schematic diagram illustrating the image sensor and pupil division according to the first embodiment.

FIG. 7 shows a relationship between a defocus amount and an image shift amount according to the first embodiment.

FIG. 8 is a schematic diagram illustrating refocusing processing according to the first embodiment.

FIG. 9 is a schematic diagram illustrating a refocusable range according to the first embodiment.

FIG. 10 is a schematic diagram showing a setting screen for AF microadjustment according to the first embodiment.

FIG. 11 is a main flowchart of a CAL mode according to the first embodiment.

FIG. 12 is a schematic diagram showing a screen displaying correction values for the CAL mode according to the first embodiment.

FIG. 13 is a flowchart of phase-difference AF according to the first embodiment.

FIG. 14 is a flowchart of focus bracket shooting according to the first embodiment.

FIGS. 15A and 15B are schematic diagrams showing parameters related to focus bracket shooting according to the first embodiment.

FIG. 16 is a flowchart of image selection operations according to one embodiment.

FIGS. 17A to 17C are schematic diagrams for explaining changes in the resolving powers for refocused images.

FIG. 18 is a flowchart of image selection operations according to a second embodiment.

FIG. 19 is a schematic diagram showing resolution reduction processing according to the second embodiment.

FIG. 20 is a flowchart of image selection operations according to a third embodiment.

FIG. 21 is a schematic diagram showing resolution enhancement processing according to the third embodiment.

### DESCRIPTION OF THE EMBODIMENTS

The following describes embodiments of the present invention in detail with reference to the attached drawings.

### First Embodiment

### [Overall Configuration]

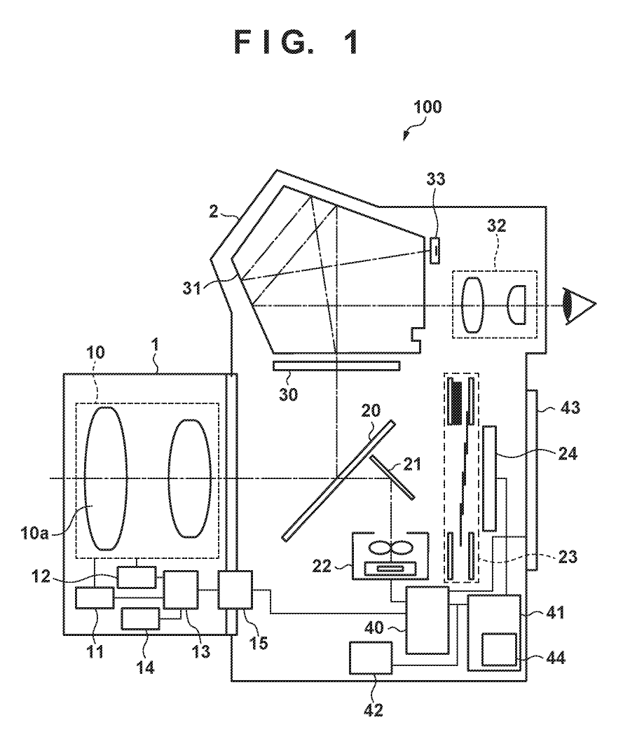

FIG. 1 shows a system configuration of a digital single-lens reflex camera according to a first embodiment. In FIG. 1, a camera system 100 is composed of a camera 2 and an interchangeable lens 1 that is attachable to and detachable from the camera 2. This camera system 100 has a function of executing autofocus (AF) processing based on a phase-difference detection method, a function of generating a refocused image by changing an in-focus position of a captured image after shooting, and a focus calibration function of correcting a focus detection result based on the phase-difference detection method.

An imaging optical system 10 is housed in the interchangeable lens 1. The imaging optical system 10 is composed of a plurality of lens units and a diaphragm. Focusing can be performed by moving a focusing lens unit (hereinafter, simply referred to as a focusing lens) 10a, which is one of the plurality of lens units, along an optical axis.

A lens driving unit 11 includes an actuator that moves a zoom lens and the focusing lens 10a, a driving circuit for the actuator, and a transmission mechanism that transmits a driving force of the actuator to each lens. A lens state detection unit 12 detects the positions of the zoom lens and the focusing lens 10a, that is, a zoom position and a focus position.

A lens control unit 13 is constituted by, for example, a CPU, and controls the operations of the interchangeable lens 1 in accordance with instructions from a later-described camera control unit 40. The lens control unit 13 is connected to the camera control unit 40 via a communication terminal included among electric contacts 15 in such a manner that they can communicate with each other. Power is supplied from the camera 2 to the interchangeable lens 1 via a power source terminal included among the electric contacts 15. A lens storage unit 14 is constituted by, for example, a ROM, and stores various types of information, such as data used in control performed by the lens control unit 13, identification information of the interchangeable lens 1, and optical information of the imaging optical system 10.

In the camera 2, during optical viewfinder observation in which a user observes an object through an optical finder, a main mirror 20 constituted by a half-silvered mirror is placed at a down position on an imaging optical path and reflects light from the imaging optical system 10 toward a focusing screen 30 as shown in FIG. 1. On the other hand, during live-view observation in which live-view images are displayed on a backside monitor 43, or during shooting in which an image (a still image or moving images) to be recorded is generated, the main mirror 20 pivots to be placed at an up position, thereby withdrawing from the imaging optical path. As a result, light from the imaging optical system 10 is directed toward a shutter 23 and an image sensor 24.

A sub mirror 21 pivots together with the main mirror 20, and directs light transmitted through the main mirror 20 placed at the down position toward an autofocus (AF) sensor unit 22. When the main mirror 20 pivots to be placed at the up position, the sub mirror 21 also withdraws from the imaging optical path.

The AF sensor unit 22 detects a focus state of the imaging optical system 10 (focus detection) in a plurality of focus detection areas set within an imaging range of the camera 2 based on the phase-difference detection method using incident light from an object that has passed through the imaging optical system 10 and been reflected by the sub mirror 21. The AF sensor unit 22 includes a secondary image-forming lens that forms a pair of images (object images) using light from each focus detection area, and an area sensor (a CCD or CMOS sensor) having a pair of light-receiving element columns that photoelectrically converts the pair of object images. A pair of light-receiving element columns in the area sensor outputs a pair of image signals, that is, photoelectrically converted signals corresponding to the luminance distributions of the pair of object images, to the camera control unit 40. A plurality of pairs of light-receiving element columns corresponding to the plurality of focus detection areas are arranged two-dimensionally in the area sensor.

The camera control unit 40 calculates a phase difference between a pair of image signals, and calculates a focus state (a defocus amount) of the imaging optical system 10 from the phase difference. Furthermore, based on the detected focus state of the imaging optical system 10, the camera control unit 40 calculates an in-focus position to which the focusing lens 10a is to be moved to achieve an in-focus state with the imaging optical system 10. Automatic focus adjustment that uses such a focus detection method is called phase-difference autofocus (AF).

Then, the camera control unit 40 transmits a focus instruction to the lens control unit 13 to move the focusing lens 10a to the in-focus position calculated based on the phase-difference detection method. The lens control unit 13 moves the focusing lens 10a to the in-focus position via the lens driving unit 11 in accordance with the received focus instruction. As a result, the imaging optical system 10 achieves the in-focus state.

As described above, phase-difference AF is performed by detecting a focus state based on the phase-difference detection method, calculating an in-focus position based on the focus state, and moving the focusing lens 10a to the in-focus position. The camera control unit 40 functions as focus control means.

The camera control unit 40 also functions as reliability degree determination means that determines whether the reliability of phase-difference AF with respect to an object targeted for phase-difference AF is high or low by calculating a reliability degree of phase-difference At with respect to the object (an image signal reliability degree) using information related to a pair of image signals from the AF sensor unit 22. In the present embodiment, a reliability degree of phase-difference AF with respect to an object is basically a reliability degree of a defocus amount (a focus state) acquired using a pair of image signals from the AF sensor unit 22 that receives light from the object. Note that this reliability degree can be ultimately considered as a reliability degree of an in-focus position based on a phase difference, because the in-focus position based on the phase difference is calculated from a defocus amount. In the following description, a reliability degree of phase-difference AF with respect to an object may simply be referred to as a reliability degree.

For example, a select level (S level) value SL disclosed in Japanese Patent Laid-Open No. 2007-52072 is used as a reliability degree. Serving as information related to a pair of image signals, the S level value SL depends on such parameters as a degree of match U, the number of edges (a correlated change amount ΔV), sharpness SH, and a contrast ratio PBD of the pair of image signals, and is given by the following expression. The higher the reliability, the smaller the S level value SL.

S_Level=U/(ΔV×SH×PBD)

Note that the information related to the pair of image signals may not necessarily be information related to both of the pair of image signals, and may be information related to one of the pair of image signals. Furthermore, the degree of match U, correlated change amount ΔV, sharpness SH, and contrast ratio PBD may be rephrased as information acquired from the pair of image signals. The information acquired from the pair of image signals is not limited to these, and may include, for example, a charge accumulation period T.

As the light-receiving elements are arranged two-dimensionally in the area sensor of the AF sensor unit 22, focus detection can be performed by detecting the luminance distribution of an object in both the horizontal direction and the vertical direction in the same field-of-view area (e.g., a central area) within the imaging range. This wall be described later in detail.

The shutter 23 closes during optical viewfinder observation, and opens during live-view observation and shooting of moving images to allow the image sensor 24 to photoelectrically convert object images formed by the imaging optical system 10 (generate live-view images and shot moving images). It also controls exposure of the image sensor 24 by opening and closing at a set shutter speed during shooting of a still image.

The image sensor 24 is composed of a CMOS or CCD image sensor and its peripheral circuit, and outputs analog imaging signals by photoelectrically converting object images formed by the imaging optical system 10. In the image sensor 24, a plurality of pixels are disposed that have a pupil division function and serve as both imaging pixels and focus detection pixels. This will be described later in detail.

The focusing screen 30 is placed at a primary image-forming plane of the imaging optical system 10, which is equivalent to the position of the image sensor 24. During optical viewfinder observation, object images (viewfinder images) are formed on the focusing screen 30. A pentaprism 31 converts object images formed on the focusing screen 30 into erect images. An eyepiece lens 32 allows the user to observe the erect images. The focusing screen 30, the pentaprism 31, and the eyepiece lens 32 constitute an optical viewfinder.

An AE sensor 33 receives light from the focusing screen 30 via the pentaprism 31, and measures the luminances of object images formed on the focusing screen 30. The AE sensor 33 has a plurality of photodiodes, and can measure the luminances in each of a plurality of photometric areas set by dividing the imaging range of the camera 2. It not only measures the luminances of object images, but also has an object detection function of determining an object state by measuring the shapes and colors of object images.

The camera control unit 40 is constituted by a microcomputer including an MPU and the like, and controls the operations of the entire camera system 100 including the camera 2 and the interchangeable lens 1. The camera control unit 40 functions not only as the focus control means as mentioned earlier, but also as later-described AF calibration means (referred to as an AF microadjustment function in the present embodiment). It also functions as imaging control means that controls imaging operations, the reliability degree determination means, and a counter for counting the number of times shooting has been performed in focus bracket shooting.

A digital signal processing unit 41 converts analog imaging signals from the image sensor 24 into digital imaging signals, and generates image signals (image data) by applying various types of processing to the digital imaging signals. The image sensor 24 and the digital signal processing unit 41 constitute an imaging system.

The digital signal processing unit 41 detects a focus state based on the phase-difference detection method using the plurality of pixels with the pupil division function arranged in the image sensor 24. The digital signal processing unit 41 also calculates a position to which the focusing lens 10a is to be moved to achieve an in-focus state with the imaging optical system 10 based on the detected focus state of the imaging optical system 10; this calculation is referred to as second focus detection (hereinafter referred to as imaging plane phase-difference autofocus (AF)).

The digital signal processing unit 41 includes a refocused image generation unit 44 that changes an in-focus position of a shot image after shooting. Refocusing processing executed to generate a refocused image will be described later in detail. A camera storage unit 42 stores various types of data used in the operations of the camera control unit 40 and the digital signal processing unit 41. The camera storage unit 42 also stores images that have been generated to be recorded. The backside monitor 43 is constituted by a display element, such as a liquid crystal panel, and displays live-view images, images to be recorded, and various types of information.

[Layout of Focus Detection Areas]

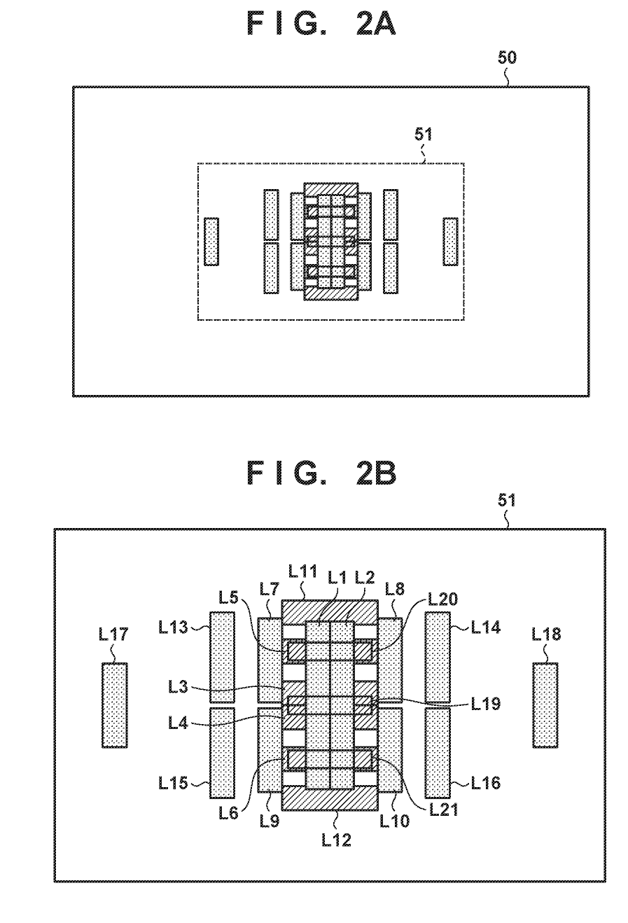

FIGS. 2A and 2B are schematic diagrams showing the layout of the focus detection areas in the area sensor of the AF sensor unit 22 according to the present embodiment.

FIG. 2A shows the layout of the focus detection areas within the imaging range. Reference numeral 50 denotes the imaging range of the camera. Reference numeral 51 denotes a later-described range in which the focus detection areas are disposed. (hereinafter, a focus detection range) within the imaging range 50. FIG. 2B is an enlarged view of the focus detection range 51. There are 21 linear focus detection areas (hereinafter, focus detection lines) within the focus detection range 51. In a central area of the focus detection range 51, two focus detection lines L1 and L2 that are long in an up-down direction (focus detection direction) are disposed, as well as two focus detection lines L3 and L4 that are long in a crosswise direction (focus detection direction); hereinafter, focus detection lines that are long in the up-down direction and focus detection lines that are long in the crosswise direction will be referred to as upright lines and crosswise lines, respectively.

In upright lines, a correlation direction coincides with the up-down direction (the direction of short edges of the image sensor 24), and a focus state of the imaging optical system 10 is detected from the luminance distribution in the up-down direction. On the other hand, in crosswise lines, a correlation direction coincides with the crosswise direction (the direction of long edges of the image sensor 24), and a focus state of the imaging optical system 10 is detected from the luminance distribution in the crosswise direction.

The two upright focus detection lines L1 and L2 that are disposed next to each other are misaligned by a minute amount in the up-down direction. This amount of misalignment is half of the pitch of pixels arrayed in the correlation direction. Variation in focus detection is alleviated by calculating a detection result in consideration of the two focus detection results obtained from the focus detection lines L1 and L2 that are misaligned by half of the pixel pitch. Similarly to the focus detection lines L1 and L2, the two crosswise focus detection lines L3 and L4 that are disposed next to each other are misaligned by half of the pixel pitch to alleviate variation in focus detection.

The central area of the focus detection range 51 also has one crosswise focus detection line L19 which has a large base-line length and in which focus detection is performed using a light beam corresponding to f/2.8. In the focus detection line L19, as its base-line length is larger than those of the focus detection lines L3 and L4, images move by a large amount on a light-receiving plane of the area sensor included in the AF sensor unit 22. Therefore, in this line, focus detection can be achieved with high precision compared with the focus detection lines L3 and L4.

Note that as the focus detection line L19 uses a light beam corresponding to f/2.8, it is effective only when a high-brightness interchangeable lens having the maximum aperture of f/2.8 or less is attached. Furthermore, this line is inferior to the focus detection lines L3 and L4 in the ability to detect large defocus because images move by a large amount therein. As described above, when a high-brightness interchangeable lens having the maximum aperture of f/2.8 or less and requiring high detection precision is attached, the focus detection line 119 corresponding to f/2.8 (hereinafter referred to as an f/2.8 line) can achieve high-precision detection as required.

In the AF sensor unit 22, as upright and crosswise focus detection lines are disposed to cross one another in the central area of the focus detection range 51, the luminance distribution can be detected in both the up-down direction and the crosswise direction. As the luminance distribution is acquired in both the up-down direction and the crosswise direction, there is no need to forcedly perform focus detection in a direction that does not exhibit a significant luminance distribution among the up-down and crosswise directions; thus, variation in detection can be alleviated. As a result, focus detection can be performed with respect to a wider variety of objects, and the detection precision can be increased. As described above, in the central area of the focus detection range 51, three focus detection results can be obtained from the upright lines (L1, L2), crosswise lines (L3, L4), and f/2.8 line (L19).

A description is now given of focus detection lines that are disposed in upper and lower parts of the focus detection range 51. In the upper part of the focus detection range 51, crosswise lines L5 and L11 are disposed in which a focus state of the imaging optical system 10 is detected from the crosswise luminance distributions of object images located in the upper part of the focus detection range 51. In the lower part of the focus detection range 51, crosswise lines L6 and L12 are disposed in which a focus state of the imaging optical system 10 is detected from the crosswise luminance distributions of object images located in the lower part of the focus detection range 51. Furthermore, a crosswise f/2.8 line L20 is disposed at the same position as the focus detection line 15, and a crosswise f/2.8 line L21 is disposed at the same position as the crosswise line L6. Accordingly, when a high-brightness interchangeable lens having the maximum aperture of f/2.8 or less and requiring high detection precision is attached, focus detection can be achieved with high precision.

Focus detection lines L7 and L9 are disposed next to each other in the up-down direction in contact with the left edges of the focus detection lines L3, L4, L5, L6, L11, and L12, and focus detection lines L8 and L10 are disposed next to each other in the up-down direction in contact with the right edges of the focus detection lines L3, L4, L5, L6, L11, and L12. The focus detection lines L7, L9, L8, and L10 are upright lines in which a focus state of the imaging optical system 10 is detected from the luminance distribution in the up-down direction.

Focus detection lines L13 and L15 are disposed next to each other in the up-down direction to the left of the focus detection lines L7 and L9, and focus detection lines L14 and L16 are disposed next to each other in the up-down direction on the outer side of the focus detection lines L8 and L10. The focus detection lines L13, L14, L15, and L16 are also upright lines in which a focus state of the imaging optical system 10 is detected from the luminance distribution in the up-down direction.

Focus detection lines L17 and L18 are disposed as outermost lines in the crosswise direction. The centers of the focus detection lines L17 and L18 in the up-down direction are on the optical axis, and in these lines, a focus state of the imaging optical system 10 is detected from the up-down luminance distributions of object images located at the opposite ends of the focus detection range 51 in the crosswise direction.

[Image Sensor]

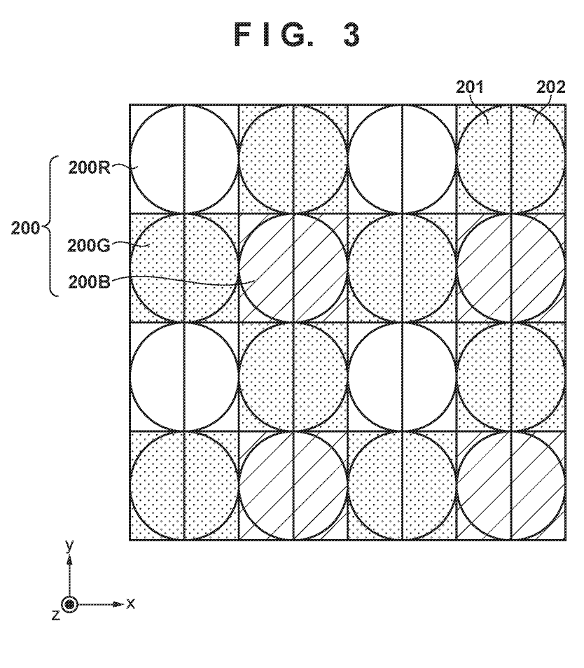

FIG. 3 is a schematic diagram showing a two-dimensional array of pixels in the image sensor 24. In a pixel group 200 composed of two pixel columns and two pixel rows shown in FIG. 3, a pixel 200R with spectral sensitivity for red (R) is located at the upper left, pixels 200G with spectral sensitivity for green (G) are located at the upper right and lower left, and a pixel 200B with spectral sensitivity for blue (B) is located at the lower right. Furthermore, each pixel is composed of a first photoelectric converter 201 and a second photoelectric converter 202 that are arrayed in two columns and one row, and functions as a focus detection pixel as well. When each pixel functions as a focus detection pixel, the structure shown in FIG. 3 where photoelectric converters are arranged in two columns and one row in each pixel represents a crosswise-line arrangement that enables detection of a focus state from the luminance distributions in the crosswise direction (e.g., an up-down line). On the other hand, the structure where photoelectric converters are arranged in one column and two rows in each pixel represents an upright-line arrangement that enables detection of a focus state from the luminance distributions in the up-down direction (e.g., a crosswise line). Furthermore, the structure where four photoelectric converters are arranged in two columns and two rows in each pixel enables detection of a focus state from the luminance distributions in both the crosswise direction and the up-down direction.

Image signals and focus detection signals can be acquired by arranging pixels shown in FIG. 3, that is, pixels in four columns and four rows (photoelectric converters in eight columns and four rows), in large numbers on an imaging plane. It will be assumed that the image sensor used in the present embodiment has the following properties: a pixel period P is 4 μm, the number of pixels N is 5,575 columns (in the crosswise direction)×3,725 rows (in the up-down direction)=20,750,000 approximately, a photoelectric converter period in a column direction PAP is 2 μm, and the number of photoelectric converters NAP is 11,150 columns (in the crosswise direction)×3,725 rows (in the up-down direction)=41,500,000 approximately.

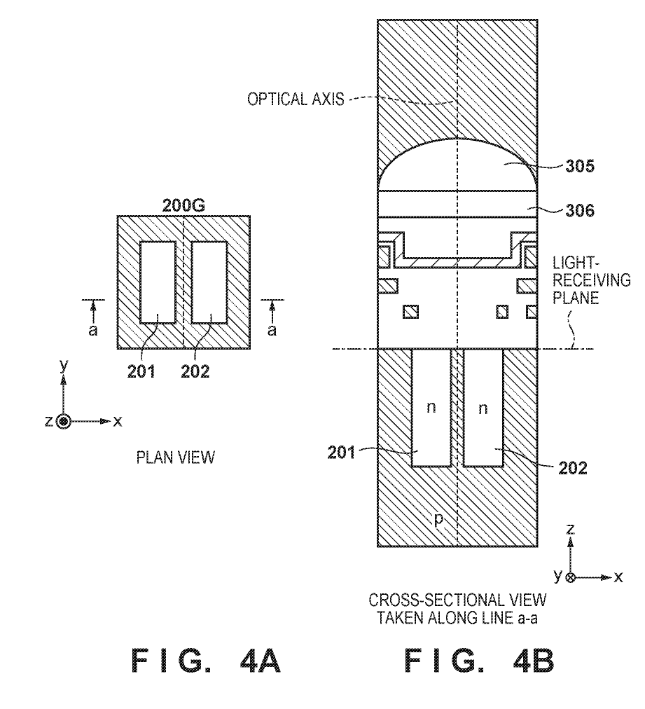

FIG. 4A is a plan view of one pixel 200G in the image sensor, which is shown in FIG. 3, as viewed in a direction facing toward a light-receiving plane of the image sensor (in a z-direction from the positive side), and FIG. 4B shows a cross-section of this pixel taken along the line a-a in FIG. 4A as viewed in a y-direction from the negative side.

As shown in FIGS. 4A and 4B, the pixel 200G is provided with a microlens 305 for collecting incident light onto the light-receiving side of the pixel, as well as a photoelectric converter divided into NH (two) in the x-direction and NV (one) in the y-direction, that is, the photoelectric converters 201 and 202. Each of the photoelectric converters 201 and 202 may be a pin photodiode having a p-type layer, an intrinsic layer, and an n-type layer in this order, or may be a p-n junction photodiode without an intrinsic layer if necessary. In each pixel, a color filter 306 is formed between the microlens 305 and the photoelectric converters 201 and 202. If necessary, the spectral transmittance of the color filter may vary with each pixel, and each pixel may not be provided with the color filter.

Light incident on the pixel 200G shown in FIGS. 4A and 4B is collected by the microlens 305, dispersed by the color filter 306, and then received by the photoelectric converters 201 and 202. In each of the photoelectric converters 201 and 202, electrons and holes are generated in pairs in accordance with an amount of received light, and separated in a depleted layer; thereafter, the negatively charged electrons are accumulated in the n-type layer (not shown), whereas the holes are discharged to the outside of the image sensor via the p-type layer connected to a constant-voltage source (not shown). The electrons accumulated in the n-type layers (not shown) of the photoelectric converters 201 and 202 are transferred to a floating diffusion (FD) via a transfer gate, and converted into voltage signals.

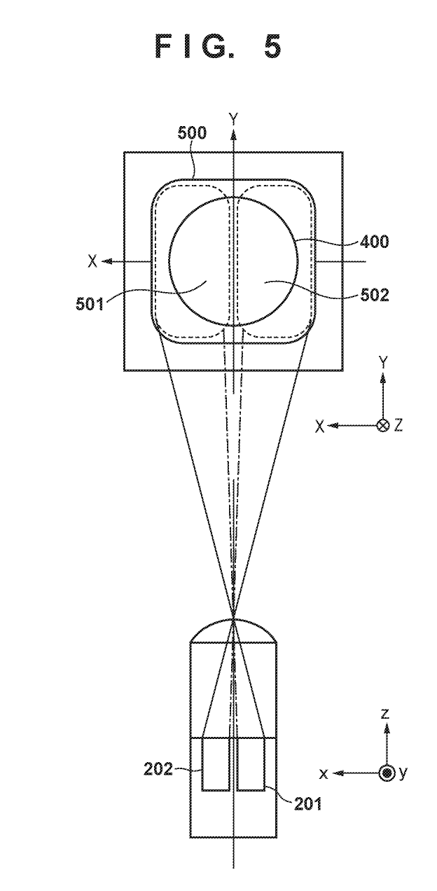

FIG. 5 is a schematic diagram illustrating a correspondence relationship between a pixel configuration shown in FIGS. 4A and 4B and pupil division. FIG. 5 shows across-section of the pixel configuration shown in FIG. 4A taken along the line a-a as viewed in the y-direction from the positive side, and an exit pupil plane of the imaging optical system 10. In FIG. 5, the x- and y-axes of the cross-section are reversed from FIGS. 4A and 4B for correspondence with the coordinate axes of the exit pupil plane.

In FIG. 5, a first partial pupil area 501 corresponding to the first photoelectric converter 201 has a roughly conjugate relationship with a light-receiving plane of the first photoelectric converter 201 whose center of mass is decentered in the −x direction due to the microlens, and represents a partial pupil area through which the first photoelectric converter 201 can receive light. The center of mass of the first partial pupil area 501 corresponding to the first photoelectric converter 201 is decentered in the +X direction on the pupil plane. With this configuration, the image sensor 24 according to the present embodiment can acquire information of the intensity of light and the direction of incidence of light, that is, so-called light field data.

In FIG. 5, a second partial pupil area 502 corresponding to the second photoelectric converter 202 has a roughly conjugate relationship with a light-receiving plane of the second photoelectric converter 202 whose center of Mass is decentered in the +x direction due to the microlens, and represents a partial pupil area through which the second photoelectric converter 202 can receive light. The center of mass of the second partial pupil area 502 corresponding to the second photoelectric converter 202 is decentered in the −X direction on the pupil plane. In FIG. 5, the entirety of the pixel 200G, including both the first photoelectric converter 201 and the second photoelectric converter 202, can receive light through a pupil area 500.

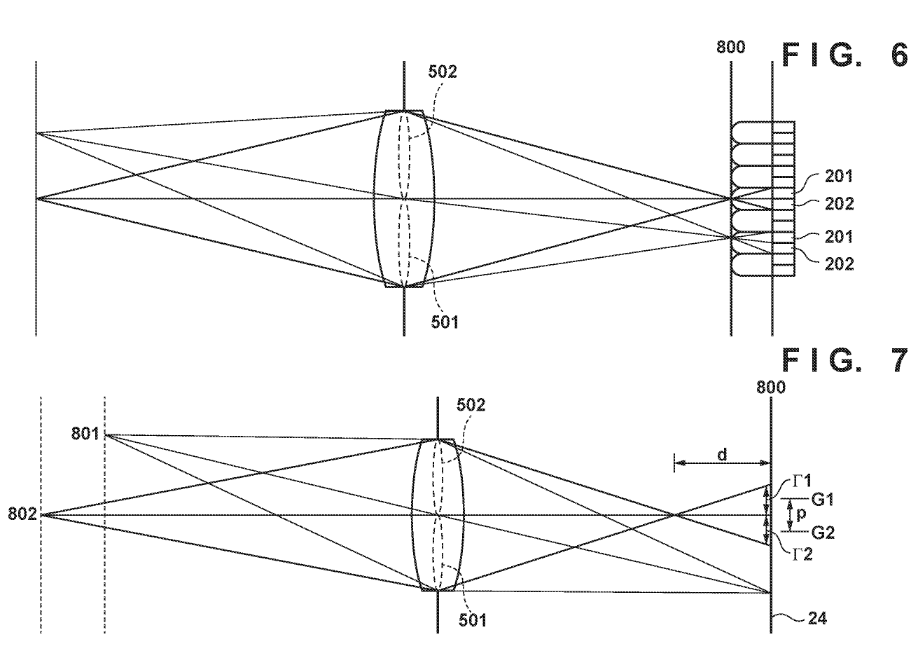

FIG. 6 is a schematic diagram showing a correspondence relationship between the image sensor and pupil division. Light beams that have passed through different partial pupil areas, that is, the first partial pupil area 501 and the second partial pupil area 502, are incident on pixels of the image sensor at different angles, and received by the first photoelectric converters 201 and the second photoelectric converters 202 obtained by 2×1 division. The present embodiment introduces an example in which the pupil area is divided into two partial pupil areas in the horizontal direction. If necessary, the pupil area may be divided in the vertical direction.

In the image sensor according to the present embodiment, a plurality of pixels are arrayed, and each pixel includes the first photoelectric converter 201 that receives a light beam passing through the first partial pupil area 501 of the imaging optical system 10, and the second photoelectric converter 202 that differs from the first partial pupil area and receives a light beam passing through the second partial pupil area 502 of the imaging optical system 10. One pixel composed of the combination of the first photoelectric converter 201 and the second photoelectric converter 202 functions as an imaging pixel that receives light beams passing through the pupil area composed of the combination of the first partial pupil area 501 and the second partial pupil area 502 of the imaging optical system 10. If necessary, the imaging pixels and the first and second photoelectric converters may be provided as separate pixel components, in which case first focus detection pixels corresponding to the first photoelectric converters and second focus detection pixels corresponding to the second photoelectric converters may be disposed in parts of the array of the imaging pixels.

In the present embodiment, focus detection is performed using first focus detection signals generated from a collection of received light signals of the first photoelectric converters 201 of the pixels in the image sensor, and second focus detection signals generated from a collection of received light signals of the second photoelectric converters 202 of the pixels. Furthermore, an imaging signal (image signal) corresponding to a resolution of the number of effective pixels N is generated by summing a signal of the first photoelectric converter 201 and a signal of the second photoelectric converter 202 for each pixel in the image sensor.

[Relationship between Defocus Amount and Image Shift Amount]

A description is now given of a relationship between a defocus amount and an image shift amount based on the first and second focus detection signals acquired by the image sensor 24. FIG. 7 schematically shows the relationship between the defocus amount and the image shift amount based on the first and second focus detection signals. The image sensor 24 is disposed on an imaging plane 800, and the exit pupil of the imaging optical system 10 is divided into two partial pupil areas, that is, the first partial pupil area 501 and the second partial pupil area 502, similarly to FIGS. 5 and 6.

Provided that a distance from an image-forming position of an object to the imaging plane 800 is defined as a magnitude |d|, a defocus amount d has a minus sign (d<0) in a front-focus state where the image-forming position of the object is closer to the object than the imaging plane 800 is, and has a plus sign (d>0) in a rear-focus state where the image-forming position of the object is farther from the object than the imaging plane 800 is. The defocus amount d is zero in an in-focus state where the image-forming position of the object is on the imaging plane 800 (an in-focus position). FIG. 7 depicts an example in which an object 801 is in an in-focus state (d=0), whereas an object 802 is in a front-focus state (d<0). A front-focus state (d<0) and a rear-focus state (d>0) are collectively defined as a defocus state (|d|>0).

In a front-focus state (d<0), among light beams from the object 802, light beams that have passed through the first partial pupil area 501 (or second partial pupil area 502) are collected and then spread to a width Γ1 (or Γ2) around the position of the center of Mass of the light beams G1 (or G2), thereby forming a blurred image on the imaging plane 800. The first photoelectric converters 201 (or second photoelectric converters 202) composing pixels arrayed in the image sensor receive the blurred image, and generate first focus detection signals (or second focus detection signals). Accordingly, the first focus detection signals (or second focus detection signals) are recorded as an image of the object 802 that has been blurred across the width Γ1 (or Γ2) at the position of the center of mass G1 (or G2) on the imaging plane 800. The blur width Γ1 (or Γ2) of the object image increases roughly in proportion to an increase in the magnitude |d| of the defocus amount d. Similarly, a magnitude |p| of an image shift amount p between the object images of the first and second focus detection signals (=a difference between the positions of the centers of mass of the light beams G1-G2) increases roughly in proportion to an increase in the magnitude |d| of the defocus amount d. The same goes for the rear-focus state (d>0), although in this case the direction of image shift between the object images of the first and second focus detection signals is reversed from the front-focus state.

Therefore, in the present embodiment, the magnitude of the image shift amount between the object images of the first and second focus detection signals increases with an increase in the defocus amount based on the first and second focus detection signals, or the defocus amount based on the imaging signal generated by summing the first and second focus detection signals. Note that in the second focus detection (imaging plane phase-difference AF), the first and second focus detection signals are relatively shifted to calculate correlation amounts indicating the degrees of match between the signals (first evaluation values), and the image shift amount is detected from a shift amount that yields high correlation (a high degree of match between the signals). As the magnitude of the image shift amount between the object images of the first and second focus detection signals increases with an increase in the magnitude of the defocus amount based on the imaging signal, the image shift amount is converted into the defocus amount in performing focus detection.

[Refocusing Processing]

A description is now given of refocusing processing that uses the aforementioned light field (LF) data acquired by the image sensor 24, and a refocusable range of the refocusing processing.

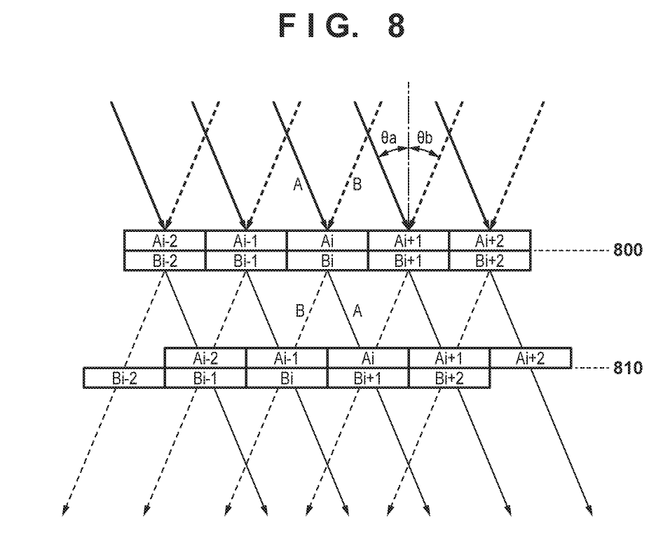

FIG. 8 is a schematic diagram illustrating refocusing processing in a one-dimensional direction (column direction or horizontal direction) based on the first and second focus detection signals acquired by the image sensor according to the present embodiment. The imaging plane 800 shown in FIG. 8 corresponds to the imaging plane 800 shown in. FIGS. 6 and 7. In FIG. 8, a first focus detection signal and a second focus detection signal of the i^{th} pixel in the column direction in the image sensor disposed on the imaging plane 800 are schematically labeled Ai and Bi, respectively, where i is an integer. The first focus detection signal Ai is a received light signal of light beams incident on the i^{th} pixel at a principal ray angle θa in correspondence with the partial pupil area 501 shown in FIG. 6. The second focus detection signal Bi is a received light signal of light beams incident on the i^{th} pixel at a principal ray angle θb in correspondence with the partial pupil area 502 shown in FIG. 6.

The first focus detection signal Ai and the second focus detection signal Bi have light intensity distribution information and incident angle information. A refocus signal at a virtual image-forming plane 810 can be generated by translating the first focus detection signal. Ai to the virtual image-forming plane 810 in accordance with the angle θa, translating the second focus detection signal Bi to the virtual image-forming plane 810 in accordance with the angle θb, and then summing the translated signals. Translation of the first focus detection signal Ai to the virtual image-forming plane 810 in accordance with the angle θa corresponds to a +0.5 pixel shift in the column direction. Translation of the second focus detection signal Bi to the virtual image-forming plane 810 in accordance with the angle θb corresponds to a −0.5 pixel shift in the column direction. Therefore, the refocus signal on the virtual image-forming plane 810 can be generated by shifting the first focus detection signal Ai and the second focus detection signal Bi relatively by +1 pixel, and summing Ai and the corresponding signal Bi+1. Similarly, by shifting the first focus detection signal Ai and the second focus detection signal Bi by an amount corresponding to an integer and summing the shifted signals, a shift summation signal (refocus signal) can be generated on any virtual image-forming plane based on the shift amount corresponding to the integer. By generating an image using the generated shift summation signal (refocus signal), a refocused image can be generated on a virtual image-forming plane.

In the present embodiment, the refocused image generation unit 44 applies second filter processing and second shift processing to the first and second focus detection signals and sums the resultant signals to generate a shift summation signal. By generating an image using the generated shift summation signal (refocus signal), a refocused image can be generated on a virtual image-forming plane. As each of the imaging pixels arrayed in the image sensor 24 according to the present embodiment is divided into two in the x-direction and one in the y-direction, a shift summation signal is generated only in the x-direction (horizontal direction or crosswise direction).

[Refocusable Range]

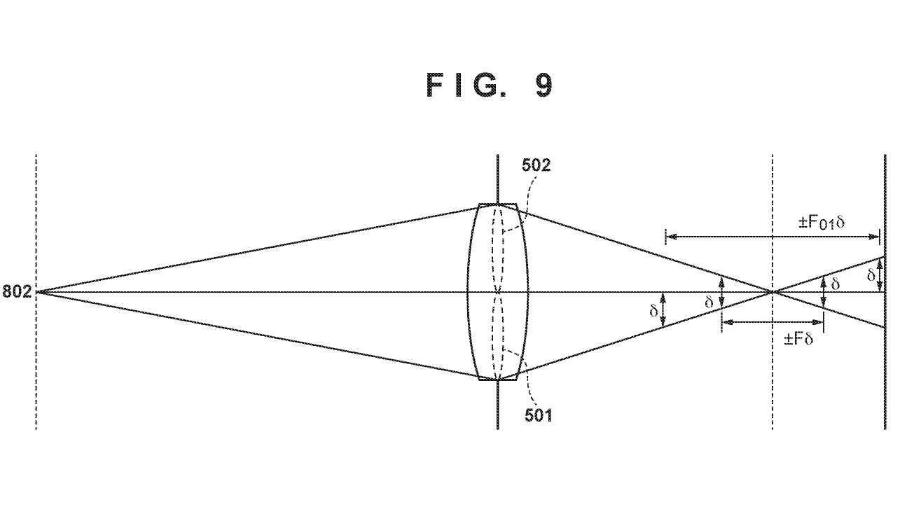

As a refocusable range is limited, a range in which the refocused image generation unit 44 can generate a refocused image on a virtual image-forming plane is limited. FIG. 9 is a schematic diagram illustrating the refocusable range according to the present embodiment.

Provided that a permissible circle of confusion 5 and an f-number of an image-forming optical system is F, a depth of field at the f-number F is ±Fδ. The effective f-number F01 (or F02) in the horizontal direction of the partial pupil area 501 (or 502), which has become narrow due to the NH—NV (2×1) division, is set as F01=NH·F, and hence dark. An effective depth of field for each first focus detection signal (or second focus detection signal) is multiplied by NH and thus becomes ±NH·Fδ, and accordingly, an in-focus range expands NH-fold. Within the range of the effective depth of field ±NH·Fδ, an in-focus object image is acquired for each first focus detection signal (or second focus detection signal). Therefore, the in-focus position can be readjusted (refocused) after shooting by executing refocusing processing for translating first focus detection signals (or second focus detection signals) in accordance with the principal ray angle θa (or θb) shown in FIG. 8. A defocus amount d for which the in-focus position can be readjusted (refocused) after shooting is limited, and roughly fails within the range of Expression 1.

|d|≦NH·Fδ Expression 1

The permissible circle of confusion δ is defined as, for example, δ=2ΔX (the reciprocal of the Nyquist frequency 1/(2ΔX) of a pixel period ΔX). If necessary, the reciprocal of the Nyquist frequency 1/(2ΔX) of a period ΔXAF of the first focus detection signals (or second focus detection signals) after pixel summation processing (=6ΔX when six pixels are summed) may be used as the permissible circle of confusion δ=2ΔXAF. In generating a refocused image on a virtual image-forming plane using a shift summation signal (refocus signal), a range in which a refocused image satisfying the permissible circle of confusion δ can be generated is roughly limited to the range of Expression 1.

[Autofocus (AF) Microadjustment Function]

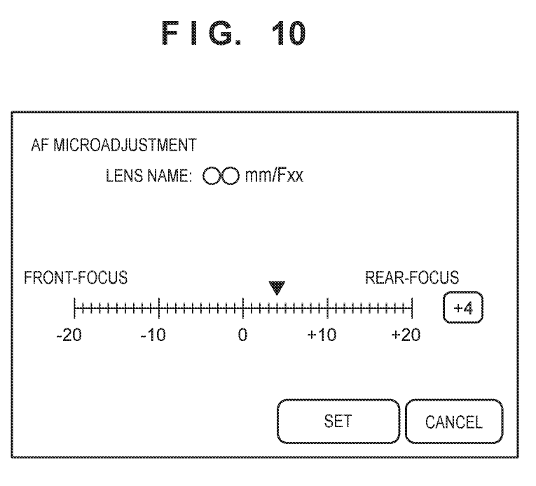

FIG. 10 shows a setting screen for AF microadjustment. The image capturing apparatus according to the present embodiment has an AF microadjustment function. The AF microadjustment function is a system that allows the user to set a correction value by determining the amount and direction of displacement between an in-focus position detected by the AF sensor unit 22 and the actual in-focus position based on an image shot by the user. This correction value is used to correct phase-difference AF performed during actual shooting (during shooting of an image to be recorded). As shown in FIG. 10, provided that a correction interval is P, AF microadjustment by the image capturing apparatus according to the present embodiment enables correction of displacement between an in-focus position detected by the AF sensor unit 22 and the actual in-focus position within a range of ±20P. In FIG. 10, “0” denotes a reference position that set as a factory setting of the camera 2.

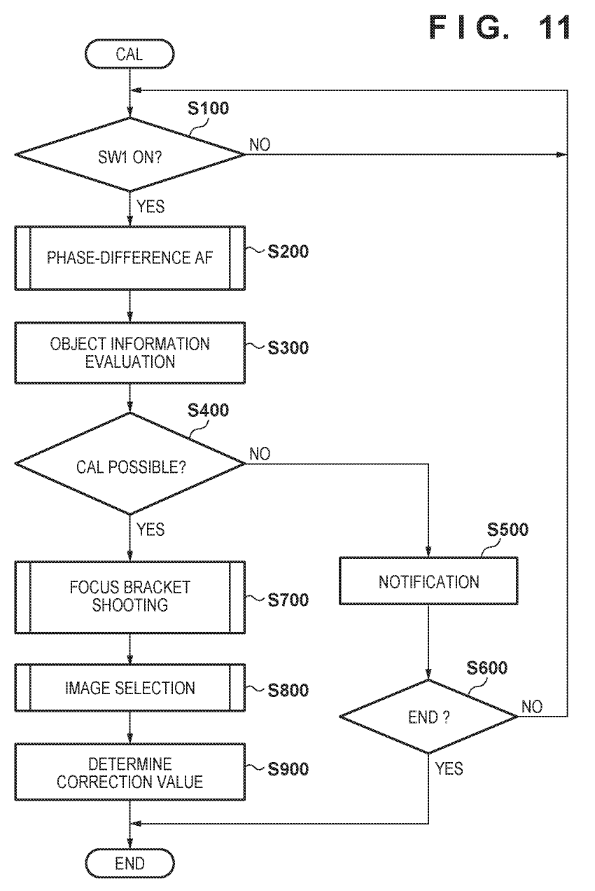

A description is now given of an autofocus (AF) calibration (hereinafter, CAL) mode of the camera 2 according to the present embodiment. FIG. 11 is a flowchart of the operations of the CAL mode according to the present embodiment.

If the user selects the CAL mode, step 5100 is executed. In step S100, the camera control unit 40 determines whether a first switch (SW1) has been turned ON by an operation of depressing a non-illustrated release switch by half. If the first switch has not been turned ON, a stand-by state follows; if the first switch has been turned ON, step S200 is executed.

In step S200, the AC sensor unit 22 performs phase-difference AF. The details will be described later. Upon completion of phase-difference AF in step S200, step S300 is executed. In step S300, object information evaluation values are calculated. Object information includes, for example, AF reliability evaluation values. The AF reliability evaluation values are calculated based on signals corresponding to light received by the area sensor provided inside the AF sensor unit 22. For example, the aforementioned S level values SL are used as the AF reliability evaluation values.

The AF sensor unit 22 may suffer a decrease in the focus detection precision when, for example, an object is dark or the contrast is low. In the case of an object that reduces the focus detection precision, the AF reliability evaluation values calculated as the object information evaluation values are small. The object information evaluation values are not limited to the AF reliability evaluation values, and may be calculated in accordance with spatial frequency information of an object or a magnitude of object edge information (e.g., an integrated value of differences between neighboring pixel values). The object information for calculating the object information evaluation values is not limited to being detected by the area sensor provided inside the AF sensor unit 22, and may be detected by an object detection function of the AC sensor 33 provided in the optical viewfinder. The object information may be detected by the image sensor 24. Upon completion of the calculation of the object information evaluation values, step S400 is executed.

In step S400, whether CAL can be performed is determined based on the object information evaluation values calculated in step S300. For example, if the AF reliability evaluation values calculated as the object information evaluation values are large, it is determined that CAL can be performed, and step S700 is executed; if the AF reliability evaluation values are small, it is determined that CAL cannot be performed, and step S500 is executed. Note that there are a plurality of AC reliability evaluation values as they are calculated from different perspectives. As stated earlier, different perspectives include the luminance of an object, the contrast of an object, and so forth. In view of this, the determination may be made based on whether all AF reliability evaluation values satisfy a predetermined condition, or based on a value associated with a certain, preset perspective. In step S500, the user is notified of the fact that an object targeted for focus detection is not suitable for CAL using the backside monitor 43. Upon completion of the notification, step 3600 is executed.

In step S600, the user determines whether to end CAL. The backside monitor 43 displays a material that allows the user to determine whether to perform CAL again, and the user determines whether to perform CAL again by operating a non-illustrated console button. If the user determines to perform CAL again, step S100 is executed again; if the user determines to end CAL, the CAL mode ends.

In step S700, focus bracket shooting is performed, that is, a plurality of images are shot while shifting the focus by moving the focusing lens 10a in increments of a predetermined amount. The details will be described later. Upon completion of the focus bracket shooting, step S800 is executed. In step S800, the user selects, from among these plurality of images, an image that the user thinks has the best focus. The details will be described later.

In step S900, a correction value is stored. The correction value is determined based on a defocus amount associated with the image selected by the user, or on a defocus amount calculated in correspondence with a lens position. The determined correction value is stored to the camera storage unit 42. Furthermore, the user is notified of the stored correction value.

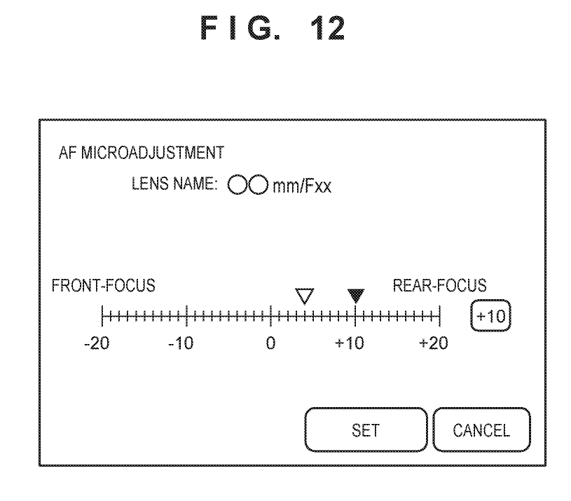

FIG. 12 shows a screen displayed on the backside monitor 43 to present the stored correction value. In FIG. 12, an outlined triangle indicates a previous correction value, whereas a filled triangle indicates a new correction value stored in the current calibration operations. The user can check the stored correction value on the displayed screen shown in FIG. 12. Upon completion of the storage of the correction value, the CAL mode ends.

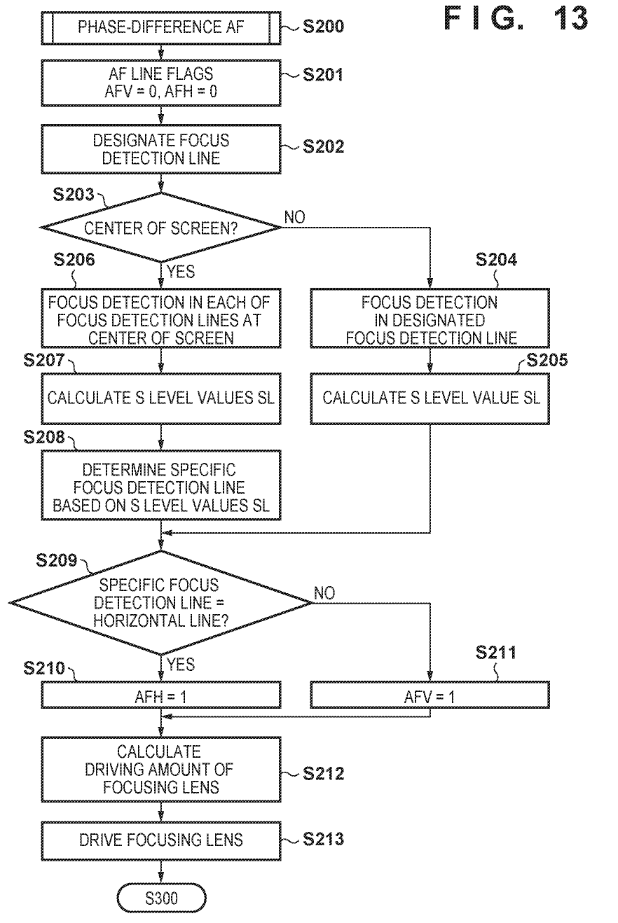

FIG. 13 shows a flow of phase-difference AF, which is a sub flow in the CAL mode according to the present embodiment.

In step S201, AF line flags are reset. The AF line flags are provided in correspondence with upright lines and crosswise lines included among the focus detection lines (L1 to L21) disposed inside the AF sensor unit 22. The AG line flag corresponding to upright lines APP, and the AG line flag corresponding to crosswise lines is AFH.

In step S202, the camera control unit 40 designates one focus detection line from among the 21 focus detection lines disposed inside the imaging range in accordance with the user's selection operation or a predetermined algorithm.

In step S203, the camera control unit 40 determines whether the focus detection line designated in step S202 is one of the focus detection lines L1 to L4 and L19 included in the central area of the focus detection range. If the designated focus detection line is not one of the focus detection lines included in the central area, step S204 is executed; if the designated focus detection line is one of the focus detection lines included in the central area, step S206 is executed.

In step S204, the camera control unit 40 imports a pair of image signals from a pair of light-receiving element columns that is included in the area sensor of the AF sensor unit 22 and corresponds to the designated focus detection line. Then, it calculates a phase difference between the pair of image signals, and calculates a defocus amount from the calculated phase difference. It also determines the designated focus detection line as a specific focus detection line. Thereafter, step S205 is executed.

In step S205, the camera control unit 40 calculates, from the pair of image signals that was imported in step S204 in correspondence with the focus detection line, a degree of match U, correlated change amount ΔV, sharpness SH, and contrast ratio PBD of the pair of image signals. It also calculates the aforementioned S level value SL using the values of these four parameters. Upon completion of the calculation of the S level value SL, step S209 is executed.

In step S206, the camera control unit 40 imports pairs of image signals from pairs of light-receiving element columns that are included in the area sensor and correspond to the focus detection lines included in the central area of the focus detection range. Then, it calculates phase differences between the pairs of image signals, and calculates defocus amounts from the calculated phase differences. Thereafter, step S207 is executed.

In step S207, the camera control unit 40 calculates S level values SL from the pairs of image signals that were imported in step S206 in correspondence with the focus detection lines, similarly to step S205. Upon completion of the calculation of the S level values SL, step S208 is executed.

In step S208, the camera control unit 40 selects a focus detection line corresponding to the smallest S level value SL (i.e., a focus detection line with high reliability) from among the focus detection lines included in the central area of the imaging range, and determines the selected focus detection line as a specific focus detection line. Thereafter, step S209 is executed.

In step S209, whether the specific focus detection line determined in step S208 or S204 is a crosswise line is determined. If the specific focus detection line is a crosswise line, step S210 is executed; if the specific focus detection line is not a crosswise line (is an upright line), step S211 is executed. In the present embodiment, two types of AF line flags, that is, the AF line flag corresponding to upright lines and the AF line flag corresponding to crosswise lines, are provided because each focus detection line in the AF sensor unit 22 is either an upright line or a crosswise line. However, the layout of the focus detection lines is not limited in this way, and a criterion for selecting the specific focus detection line and the number and types of the AF line flags may vary depending on the layout of the focus detection lines.

In step S210, the AF line flag AFH corresponding to crosswise lines is set to 1. Upon completion of the setting, step S212 is executed. In step S211, the AF line flag AFV corresponding to upright lines is set to 1. Upon completion of the setting, step S212 is executed.

In step S212, the camera control unit 40 calculates a moving amount (including a moving direction) of the focusing lens 10a necessary for achieving an in-focus state from the defocus amount in the specific focus detection line. Specifically, the number of driving pulses of the actuator in the lens driving unit 11 for moving the focusing lens 10a is calculated. Calculation of the moving amount of the focusing lens 10a is equivalent to calculation of an in-focus position based on the phase-difference detection method. If a correction amount is currently designated by the AS microadjustment function, the moving amount of the focusing lens 10a calculated in step S212 is corrected by adding (or subtracting) the correction amount designated by the AF microadjustment function to (or from) the moving amount. If the correction amount has not been generated, it means that the correction amount is zero, and thus the moving amount of the focusing lens 10a (the in-focus position based on the phase difference) is not corrected.

In step S213, the camera control unit 40 transmits a focus instruction to the lens control unit 13 so as to move the focusing lens 10a by the corrected moving amount. Accordingly, the lens control unit 13 moves the focusing lens 10a to the corrected in-focus position based on the phase difference via the lens driving unit 11. In step S212, the focusing lens 10a may be moved by the pre-correction moving amount (i.e., to the pre-correction in-focus position based on the phase difference). Then, in step S213, the focusing lens 10a may be moved again by a moving amount equivalent to the correction amount designated by the At microadjustment function; in this case, the focusing lens 10a is ultimately moved to the corrected in-focus position based on the phase difference upon completion of the foregoing phase-difference AF operations, the present sub flow returns to step S300 of the main flow in the CAL mode shown in FIG. 11.

The focusing lens 10a may be moved by other autofocus means (e.g., imaging plane phase-difference AF), rather than by phase-difference AF using the AF sensor unit 22 as described above. Upon completion of the foregoing phase-difference AF operations, the present sub flow returns to step S300 of the main flow in the CAL mode shown in FIG. 11.

FIG. 14 shows a flow of focus bracket shooting, which is a sub flow in the CAL mode according to the present embodiment.

In step S701, whether the AF line flag AFH is 1 is determined. If the AF line flag AFH is 1 (i.e., if the specific focus detection line is a crosswise line), step S704 is executed. If the AF line flag AFH is 0 (i.e., the specific focus detection line is an upright line), step S702 is executed.

In steps S702 and S703, a lens driving amount w and the number m of images to be shot in focus bracket shooting for a case in which the AFH is 0 (i.e., for a case in which the specific focus detection line is an upright line) are determined.

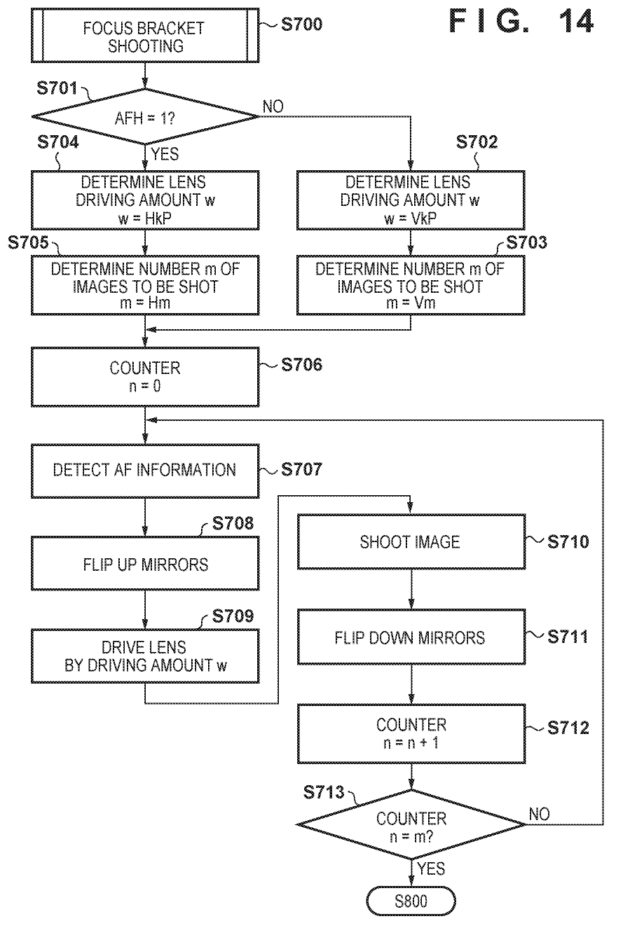

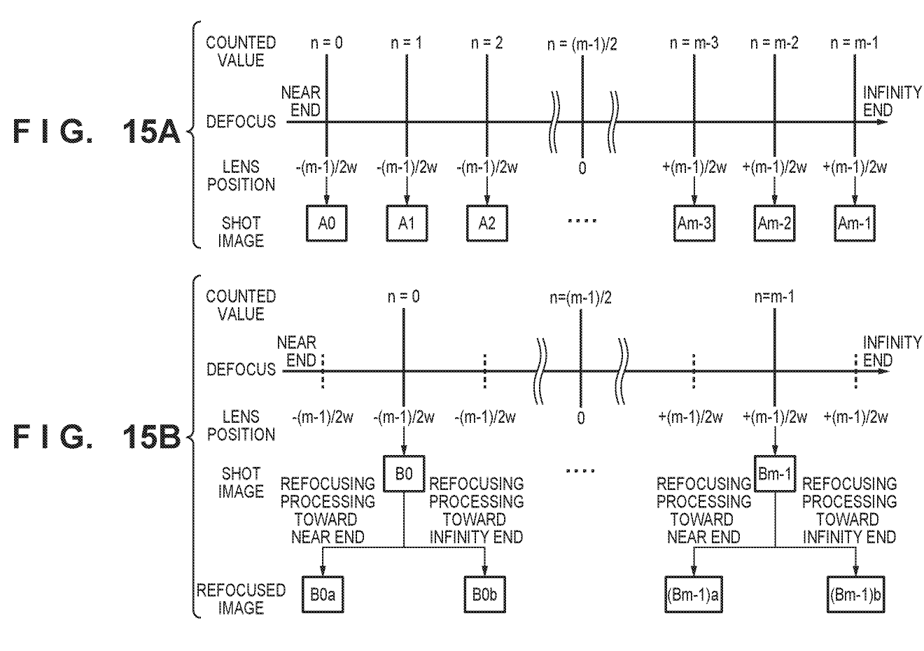

FIGS. 15A and 15B show a relationship between the lens driving amount w and the number m of images to be shot in association with focus bracket shooting. FIG. 15A pertains to a case in which the AFH is 0. In FIG. 15A, a lens position 0 denotes a position at which the focusing lens 10a has stopped after being driven by phase-difference AF of step S200 in the flowchart of FIG. 11 (a focus position), that is, a start position of the focusing lens 10a in the sub flow shown in FIG. 14. The focusing lens 10a is driven to a position corresponding to a value counted by the counter included in the camera control unit 40. The lens driving amount w is obtained by multiplying the aforementioned correction interval P of AF microadjustment by a coefficient k (k·P) (where k is an integer satisfying the relationship k≧2). In the present case, Vk, which is a value taken by the coefficient k when an upright line is selected, is substituted in the calculation of the lens driving amount w, and thus the lens driving amount w is Vk·P. In the present embodiment, the coefficient Vk is 2, and thus the lens driving amount w is Vk·P=2P. Once the lens driving amount w has been determined, step S703 is executed.

In step S703, the number m of images to be shot in focus bracket shooting is determined. When the AF line flag AFH is 0, the number Vm of images to be shot when an upright line is selected is substituted for the number m of images to be shot. In the present embodiment, the number m of images to be shot is Vm=9. Once the number m of images to be shot has been determined, step S706 is executed.

In steps S704 and S705, a lens driving amount w and the number m of images to be shot in focus bracket shooting for a case in which the AFH is 1 (i.e., for a case in which the specific focus detection line is a crosswise line) are determined.

In step S704, the lens driving amount w is determined. FIG. 15B shows a relationship between the lens driving amount w and the number m of images to be shot in association with focus bracket shooting for a case in which the AFH is 1. Similarly to the aforementioned step S702, the lens driving amount w is obtained by multiplying the correction interval P by a coefficient k (k·P). In the present case, Hk, which is a value taken by the coefficient k when a crosswise line is selected, is substituted in the calculation of the lens driving amount w, and thus the lens driving amount w is Hk·P. In the present embodiment, the lens driving amount w used when a crosswise line is selected is 6P.

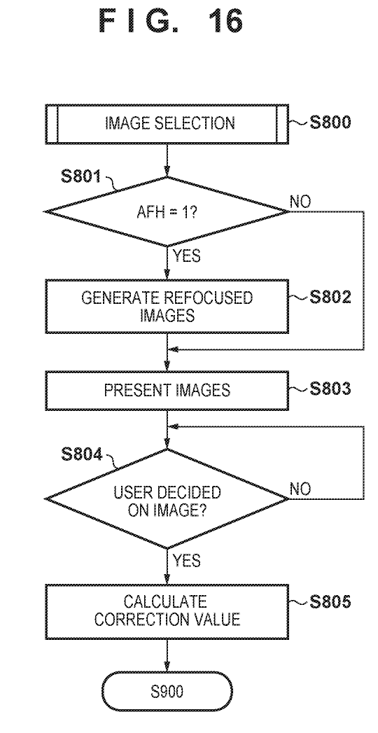

In the present embodiment, as shift summation is performed in the horizontal direction in generating refocused images, refocused images can be generated in line with a later-described image selection flowchart of FIG. 16 when the AFH is 1. That is, refocused images (B0a and B0b in FIG. 15B) can be generated within the aforementioned refocusable range from an image shot in focus bracket shooting (B0 in FIG. 15B). In other words, an image in a front-focus direction or a rear-focus direction relative to an image actually shot in focus bracket shooting can be generated by image processing. In the present embodiment, refocused images are generated by executing refocusing processing using a defocus amount equivalent to ±(m−1)/2w. Therefore, as shown in FIG. 15B, a refocused image B0a (equivalent to a shot image A0 in FIG. 15A) can be generated by executing processing for refocusing a shot image B0 toward the infinity end using a defocus amount equivalent to +(m−1)/2w. Similarly, a refocused image B0b (equivalent to a shot image A2 in FIG. 15A) can be generated by executing processing for refocusing toward the near end. As two images (B0a and B0b) can be generated from one shot image (B0), the coefficient Hk (=6) used when a crosswise line is selected can be three times as large as the coefficient Vk (=2) used when an upright line is selected. Hence, when a crosswise line is selected, the coefficient Hk is and the lens driving amount w is HK·P=6P. That is, the lens driving amount w=Vk·P (=2P) used when an upright line is selected, and the lens driving amount w=Hk·P (=6P) used when a crosswise line is selected, satisfy the relationship Hk·P>Vk·P, meaning that the lens driving amount w can be larger when a crosswise line is selected than when an upright line is selected. Once the lens driving amount w has been determined, step S705 is executed.

In step S705, the number m of images to be shot in focus bracket shooting is determined. When the AF line flag ASH is 1, the number Hm of images to be shot when a crosswise line is selected is substituted for the number m of images to be shot. In the present embodiment, the number m of images to be shot is Hm=3. Similarly to step S704, refocused images can be generated by executing refocusing processing using a defocus amount equivalent to +(m−1)/2w. That is, as two images (B0a and B0b) can be generated from one shot image (B0), the number Hm of images to be shot when a crosswise line is selected can be one-third of the number Vm (=9) of images to be shot when an upright line is selected. In other words, the number Vm (=9) of images to be shot when an upright line is selected, and the number Hm (=3) of images to be shot when a crosswise line is selected, satisfy the relationship Vm>Hm, meaning that the number m of images to be shot can be smaller when a crosswise line is selected than when an upright line is selected. Once the number m of images to be shot has been determined, step S706 is executed.

Although the number m of images to be shot is set by the camera in the present embodiment, it may be freely set by the user. Making the number m changeable according to the level of the user can provide a system suitable for the user. Furthermore, although the number m of images to be shot and the lens driving amount w are variables in the present embodiment, one or both of them may be a fixed value in the camera 2 or the interchangeable lens 1.

In step S706, the camera control unit 40 resets the counter (sets a counted value n to 0). Upon completion of the resetting of the counter, step S707 is executed. In step S707, AF information is detected from the AF sensor unit 22. In this detection, the specific focus detection line determined in step S204 or S208 of the sub flow of phase-difference AF shown in FIG. 13 is used. The AF information includes, for example, information related to a focus state (defocus amount) and a pair of image signals. Upon completion of the detection of the AF information, step S708 is executed.

In step S708, the mirrors are flipped up. Once the main mirror 20 and the sub mirror 21 have withdrawn to the up position, step S709 is executed. In step S709, the focusing lens 10a is driven. As shown in FIGS. 15A and 15B, when the counted value n is 0, the focusing lens 10a moves to a position—(m−1)/2w. When the counted value n satisfies the relationship n≧1, the focusing lens 10a moves from the position at which it has stopped toward the infinity end by +w. Upon completion of the driving of the focusing lens 10a, step S710 is executed.

In step S710, a still image is shot. The shot image is stored to the camera storage unit 42 in association with the AF information acquired in step S707 and a lens position. Upon completion of the recording of the shot image, step S711 is executed. In step S711, the mirrors are flipped down. Accordingly, the main mirror 20 and the sub mirror 21 move to the down position. Once the mirrors have been flipped down, step S712 is executed.

In step S712, the value counted by the counter included in the camera control unit 40 is incremented by one (n=n+1). Upon completion of the increment, step S713 is executed. In step S713, whether the value counted by the counter included in the camera control unit 40 has reached the number m of images to be shot (n=m−1) is determined. If the counted value has not reached the number m of images to be shot, step S703 is executed again; if the counted value has reached the number m of images to be shot, the present sub flow of the focus bracket shooting operations is completed. Upon completion of the foregoing focus bracket shooting operations, the present sub flow returns to step S800 of the main flow in the CAL mode shown in FIG. 11.

FIG. 16 shows a flow of image selection, which is a sub flow in the CAL mode according to the present embodiment.

In step S801, whether the AG line flag AFH corresponding to crosswise lines is 1 is determined. If the AF line flag AFH corresponding to crosswise lines is 1 (i.e., if the specific focus detection line is a crosswise line and the AG information is detected in crosswise focus detection lines in CAL), step S802 is executed. If the AG line flag AFH corresponding to crosswise lines is 0 (i.e., if the specific focus detection line is an upright line and the AF information is detected in upright focus detection lines in CAL), step S803 is executed.

In step S802, the refocused image generation unit 44 generates refocused images by performing shift summation in the horizontal direction. In the present embodiment, as each photoelectric converter of the image sensor 24 is divided into two in the x-direction and one in the y-direction, shift summation is performed only in the x-direction (horizontal direction or crosswise direction) in generating refocused images. Therefore, in the present sub flow, generation of refocused images is permitted only when a crosswise line, in which a focus state is detected from the luminance distribution in the x-direction (horizontal direction or crosswise direction), is selected (i.e., only when the AF line flag AFH corresponding to crosswise lines is 1). Upon completion of the generation of the refocused images, step S803 is executed.

In step S803, the backside monitor 43 presents images (display images) to the user. In this step, images that were actually shot in focus bracket shooting (i.e., shot images to which refocusing processing has not been applied) are presented together with the refocused images if the refocused images were generated in step S802. These images may be displayed one by one, or may be displayed altogether next to one another. Upon completion of the presentation of the images, step S804 is executed.

In step S804, whether the user has decided on an image is determined. The user selects and decides on an image that has the best focus from among the presented images. A standby state lasts until this selection. Once the user has decided on the image, step S805 is executed.

In step S805, a correction value is calculated based on the image selected in step S804. A defocus amount corresponding to the AF information acquired in step S707 of the flow of focus bracket shooting shown in FIG. 14 or to a lens position is calculated and associated with each image as correction value information. The correction value is determined by calculating the correction value using AF correction value information associated with the image selected by the user. If a refocused image is selected in step S804, a difference between a defocus amount of an image serving as the basis of the selected refocused image and a defocus amount of the selected refocused image is calculated, and a value obtained by adding or subtracting the difference to or from a defocus amount associated with the image serving as the basis of the selected refocused image is associated as the correction value information. The correction value is determined by calculating the correction value using such correction value information. A value calculated by defocus amount interpolation using shot images in a front-focus direction and a rear-focus direction relative to the selected refocused image may be associated as the correction value information, and the correction value may be determined based thereon. Upon completion of the foregoing image selection operations, the present sub flow returns to step S900 of the main flow in the CAL mode shown in FIG. 11.

Although step S802 according to the present embodiment has been described based on an example in which each photoelectric converter of the image sensor 24 is divided into two in the x-direction and one in the y-direction, the present invention is not limited in this way. For example, when each photoelectric converter of the image sensor is divided into one in the x-direction and two is the y-direction, shift summation is performed only in the y-direction (vertical direction or up-down direction) in generating refocused images. In this case, during image selection in the CAL mode, generation of refocused images is permitted only when an upright line, in which a focus state is detected from the luminance distribution is the y-direction (vertical direction or up-down direction), is selected.

### Second Embodiment

The present embodiment differs from the first embodiment in that, after generating a plurality of images with different focuses using a refocusing technique similarly to the first embodiment, the resolving power is changed by applying image processing to a shot image or an image generated by the refocused image generation unit. For simplicity, it will be assumed that the AF microadjustment function is implemented only with respect to crosswise lines (in the direction in which a shift summation signal is generated in refocusing processing). Note that the present embodiment is also applicable to an image capturing apparatus that implements the AF microadjustment function with respect to both upright lines and crosswise lines as in the first embodiment.

In some cases, the resolving power for the original image cannot be reproduced by an image generated by the refocusing technique, that is, the resolving power for the image generated by the refocusing technique is inferior to the resolving power for the original image. In view of this, the present embodiment will focus on an image capturing apparatus that can reduce a difference between the resolving power for a shot image and the resolving power for an image generated based on the shot image using the refocusing technique.

Although an overall configuration is substantially similar to that of the first embodiment, a digital processing unit 41 according to the present embodiment has a function of applying image processing to a shot image or an image generated by the refocused image generation unit 44. The image processing mentioned here denotes image processing for changing the resolving power, such as edge enhancement processing and low-pass processing.

The above-described sections [Image Sensor], [Relationship between Defocus Amount and Image Shift Amount], [Refocusing Processing], and [Refocusable Range] according to the first embodiment apply to the present embodiment as well, and thus a description thereof will be omitted.

[Resolving Powers for Refocused Images]

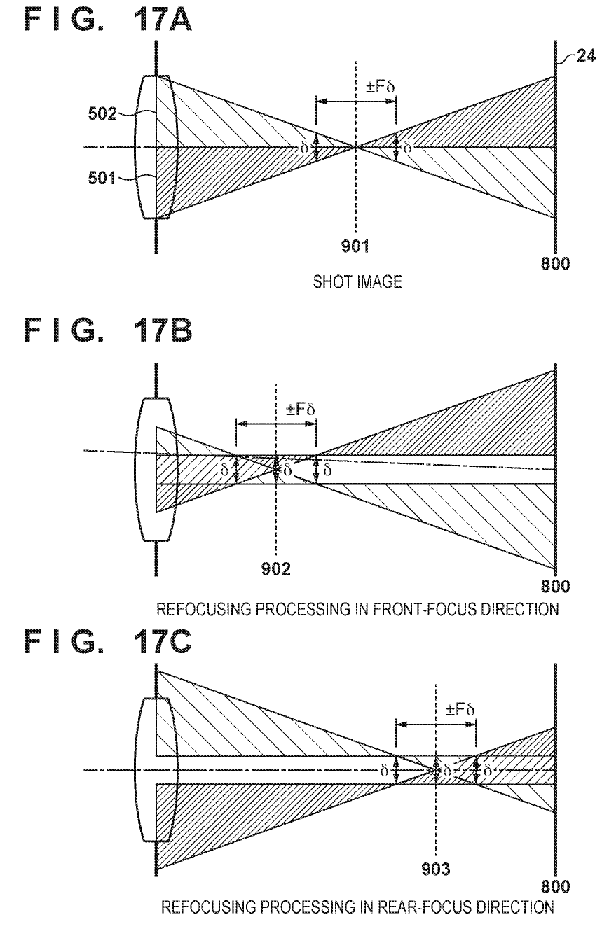

In some cases, the resolving powers for refocused images generated by the refocused image generation unit 44 based on a shift summation method are lower than the resolving power for an image actually shot. FIGS. 17A to 17C are diagrams for explaining changes in the resolving powers for refocused images in the present embodiment.

FIG. 17A shows an image shot before refocusing processing. The image sensor 24 is disposed on the imaging plane 800, and the exit pupil of the image-forming optical system is divided into two partial pupil areas, that is, the first partial pupil area 501 and the second partial pupil area 502, similarly to FIG. 8. As explained earlier in relation to the refocusable range, provided that a permissible circle of confusion is 3 and an f-number of the image-forming optical system is F, a depth of field corresponding to the f-number F satisfying the permissible circle of confusion δ is ±Fδ. In FIG. 17A, a perfect focus position of the image is 901 at which light beams that have passed through the first partial pupil area 501 (or second partial pupil area 502) are collected. As the resolving power for an object peaks at the position of light collection, the resolving power for the image shot before refocusing processing is high at the perfect focus position 901.

FIG. 17B shows a state in which refocusing processing in a front-focus direction has been applied to the shot image shown in. FIG. 17A within the refocusable range. As a result of the refocusing processing, light beams that have passed through the first partial pupil area 501 and the second partial pupil area 502 are shifted and summed, and thus the depth of field ±Fδ shifts in the front-focus direction. However, as light beams that have passed through the first partial pupil area 501 (or second partial pupil area 502) are not collected at a perfect focus position 902 of the image generated by the refocusing processing, the resolving power for the shot image cannot be reproduced. That is, the resolving power corresponding to the perfect focus position 902 of the image shown in FIG. 17B is lower than the resolving power corresponding to the perfect focus position 901 shown in FIG. 17A.

FIG. 17C shows a state in which refocusing processing in a rear-focus direction has been applied to the shot image shown in FIG. 17A within the refocusable range. Similarly to FIG. 17B, as light beams that have passed through the first partial pupil area 501 (or second partial pupil area 502) are not collected at a perfect focus position 903 of an image generated by the refocusing processing, the resolving power for the shot image cannot be reproduced. That is, the resolving power corresponding to the perfect focus position 903 of the image shown in FIG. 17C is lower than the resolving power corresponding to the perfect focus position 901 shown in FIG. 17A.

As described above, in some cases, the resolving powers for refocused images acquired by refocusing processing based on the shift summation method are lower than the resolving power for a shot image. Therefore, even if the refocused images have captured a perfect focus position of an object, a user who compares the shot image with the refocused images may not feel that the refocused images have a perfect focus.

[Autofocus (AF) Microadjustment Function]

In the present embodiment also, the AF microadjustment function can be implemented in line with the flowchart of FIG. 11 using the setting screen shown in FIG. 10. Furthermore, the phase-difference AF can be executed in line with the flowchart of FIG. 13. Note that in the present embodiment, steps S201 and S209 to S211 are skipped because the AF microadjustment function is implemented only with respect to crosswise lines. Furthermore, when the AF microadjustment function can be implemented with respect to one focus detection line, steps S202 to S208 can be skipped.

Focus bracket shooting can also be performed in line with the flowchart of FIG. 14. Note that in the flow of the focus bracket shooting, steps S701 to 703 are skipped because the AF microadjustment function is implemented only with respect to crosswise lines. Similarly to the first embodiment, steps S704 to S712 are executed; if the value counted by the counter included in the camera control unit 40 has not reached the number m of images to be shot, the flow returns to step S707, and if the counted value has reached the number m of images to be shot, the focus bracket shooting ends. Upon completion of the foregoing focus bracket shooting operations, the flow returns to step S800 of the main flow in the CAL mode shown in FIG. 11.

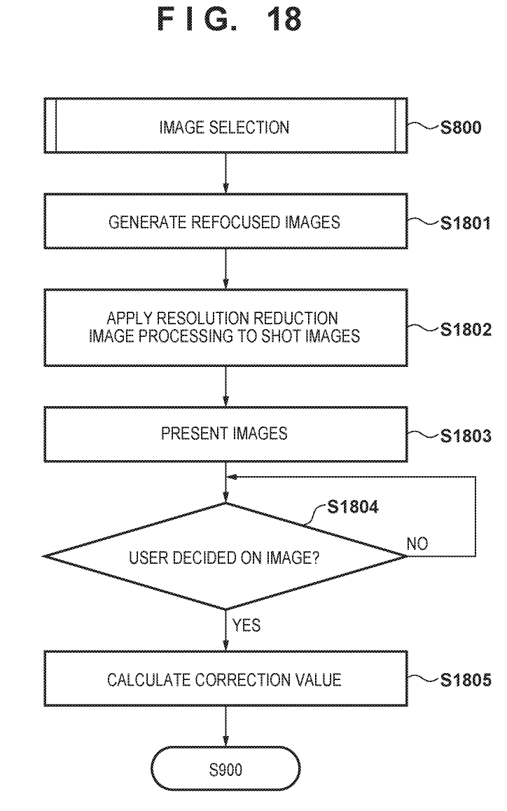

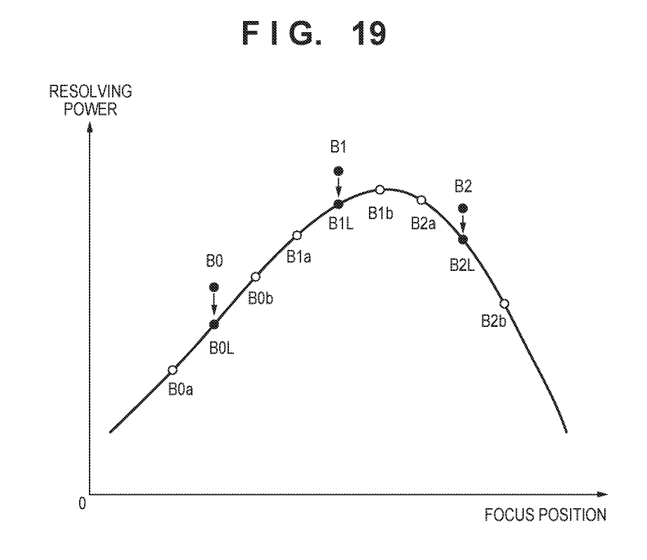

FIG. 18 shows a flow of image selection, which is a sub flow in the CAL mode according to the present embodiment.

In step S1801, the refocused image generation unit 44 generates refocused images by performing shift summation. Upon completion of the generation of the refocused images, step S1802 is executed in step S1802, resolution reduction image processing is applied to images that were actually shot in focus bracket shooting.

FIG. 19 shows changes in the resolving powers caused by application of the resolution reduction image processing to images that were actually shot. The resolving powers for images that were actually shot (B0, B1, B2) are higher than the resolving powers for images generated by refocusing processing (B0a, B0b, B1a, B1b, B2a, B2b). Therefore, the resolution reduction image processing is executed to lower the resolving powers for the shot images. As a result, the resolving powers for the shot images B0, B1, and B2 are lowered to the values B0L, B1L, and B2L, respectively, thereby eliminating the differences between the resolving powers for the refocused images and the resolving powers for the shot images. One possible example of the resolution reduction image processing is image processing for calculating contrast values of refocused images acquired by defocusing a shot image in a front-focus direction and a rear-focus direction, and lowering the resolving power to take an intermediate value between the two contrast values (low-pass processing). Another possible example is image processing for lowering the resolving power based on a table showing a reduction in the resolving power caused by refocusing processing. Upon completion of the resolution reduction image processing, step S1803 is executed.

In step S1803, the backside monitor 43 displays images to the user. The images shot in focus bracket shooting are displayed together with the refocused images generated in the aforementioned step S1801. These images may be displayed one by one, or may be displayed altogether next to one another. Upon completion of the display of the images, step S1804 is executed. In step S1804, whether the user has decided on an image is determined. The user selects and decides on an image that the user thinks has the best focus from among the displayed images. A standby state lasts until this selection. Once the user has decided on the image, step S1805 is executed.

In step S1805, a correction value is calculated based on the image selected in step S1804, A defocus amount corresponding to the AF information acquired in step S707 of the flow of focus bracket shooting shown an FIG. 14 or to a lens position is calculated and associated with each image as correction value information. The correction value is determined by calculating the correction value using AF correction value information associated with the image selected by the user, if a refocused image is selected an step S1804, a difference between a defocus amount of an image serving as the basis of the selected refocused image and a defocus amount of the selected refocused image is calculated. Then, a value obtained by adding or subtracting the difference to or from a defocus amount associated with the shot image serving as the basis of the selected refocused image is associated as the correction value information. The correction value is determined by calculating the correction value using such correction value information. A value calculated by defocus amount interpolation using shot images in a front-focus direction and a rear-focus direction relative to the selected refocused image may be associated as the correction value information, and the correction value may be determined based thereon. Upon completion of the foregoing image selection operations, the present sub flow returns to step S900 of the main flow in the CAL mode shown in FIG. 11.

### Third Embodiment

A third embodiment of the present invention will be described. Note that a description of configurations that are the same as those of the second embodiment will be omitted, and only the differences from the second embodiment will be described.

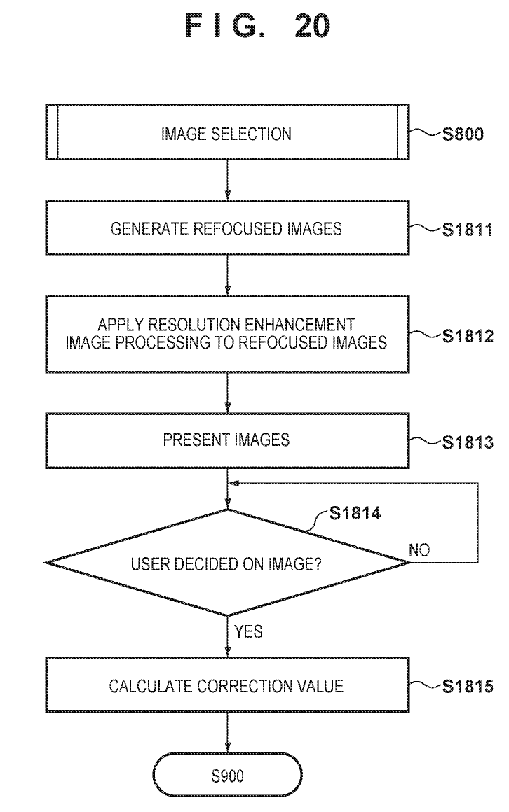

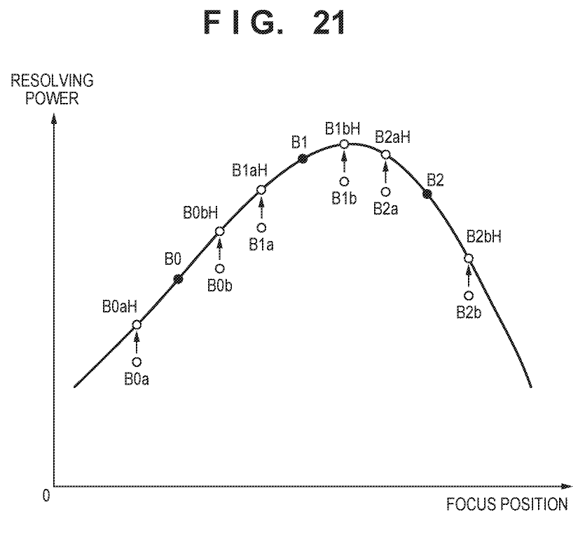

FIG. 20 shows a flow of image selection, which is a sub flow in the CAL mode according to the third embodiment of the present invention. In step S1811, the refocused image generation unit 44 generates refocused images by performing shift summation in the horizontal direction. Upon completion of the generation of the refocused images, step S1812 is executed.

In step S1812, resolution enhancement image processing is applied to the refocused images generated from images that were actually shot in focus bracket shooting. FIG. 21 shows changes in the resolving powers caused by application of the resolution enhancement image processing to refocused images. The resolving powers for images generated by refocusing processing (B0a, B0b, B1a, B1b, B2a, and B2b) are lower than the resolving powers for images that were actually shot (B0, B1, and B2). Therefore, the resolution enhancement image processing is executed to increase the resolving powers for the images generated by refocusing processing. As a result, the resolving powers for the refocused images B0a, B0b, B1a, B1b, B2a, and B2b are increased to the values B0aH, B0bH, B1aH, B1bH, B2aH, and B2bH, respectively, thereby eliminating the differences between the resolving powers for the refocused images and the resolving powers for the shot images. One possible example of the resolution enhancement image processing is image processing for achieving conformity with a contrast value of an image shot before a refocused image is generated. (edge enhancement). Another possible example is image processing for increasing the resolving power based on a table showing a reduction in the resolving power caused by refocusing processing. Upon completion of the resolution enhancement image processing, step S1813 is executed.

In step S1815, the backside monitor 43 displays images to a user. A correction value is calculated in a manner similar to step S1803 of the first embodiment. In step S1814, whether the user has decided on an image is determined. The user selects and decides on an image that the user thinks has the best focus from among the displayed images. A standby state lasts until this selection. Once the user has decided on the image, step S1815 is executed. In step S1815, a correction value is calculated based on the image selected in step S1814. The correction value is calculated in a manner similar to step S1805 of the first embodiment. Upon completion of the foregoing image selection operations, the present sub flow returns to step S900 of the main flow in the CAL mode shown in FIG. 11.

Although preferred embodiments of the present invention have been described thus far, the present invention is not limited to these embodiments, and can be modified and changed in various manners within the scope of the principles of the present invention.

For example, the above-described first embodiment has introduced an example in which resolution reduction processing is applied to shot images, and the above-described third embodiment has introduced an example in which resolution enhancement. processing is applied to refocused images. However, the present invention is not limited in this way, and image processing may be applied to both shot images and refocused images. In this case, for example, resolution reduction processing of a certain level may be applied to shot images, and resolution enhancement processing that compensates for the insufficiency caused by such resolution reduction processing may be applied to refocused images. In the present invention, it is sufficient to reduce a resolution difference between a group of shot images and a group of refocused images to bring the groups to the same resolution level by applying image processing to at least one of the groups.

Although preferred embodiments of the present invention have been described thus far, the present invention is not limited to these embodiments, and can be modified and changed in various manners within the scope of the principles of the present invention.

For example, although focus detection is performed using the AF sensor unit 22 that is dedicated to focus detection in the above-described embodiments, focus detection may be performed using the image sensor that has a plurality of photoelectric converters per unit pixel as shown in FIG. 3.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2016-080472, filed Apr. 13, 2016, and 2016-085428, filed Apr. 21, 2016, which are hereby incorporated by reference herein in their entirety.

What is claimed is:

1. An image capturing apparatus, comprising:
an image capturing unit that photoelectrically converts an object image;
a focus detection unit that detects a focus position of an imaging optical system based on a phase-difference detection method using a pair of image signals formed by light that has passed through different pupil areas of the imaging optical system;
an imaging control unit that controls the image capturing unit to make the image capturing unit acquire pieces of light field data in one-to-one correspondence with a plurality of focus positions of the imaging optical system that are obtained by shifting the detected focus position of the imaging optical system in increments of a predetermined amount; and
a generation unit that generates a refocused image corresponding to a focus position between the plurality of focus positions of the imaging optical system using the pieces of light field data, the generation depending on a direction of phase-difference detection by the focus detection unit and on a direction of parallax in the pieces of light field data.

2. The image capturing apparatus according to claim 1, wherein
the generation unit generates the refocused image when the direction of phase-difference detection by the focus detection unit corresponds to the direction of parallax in the pieces of light field data.

3. The image capturing apparatus according to claim 1, wherein
the imaging control unit makes an interval between the plurality of focus positions of the imaging optical system larger when the direction of phase-difference detection by the focus detection unit corresponds to the direction of parallax in the pieces of light field data than when the direction of phase-difference detection by the focus detection unit does not correspond to the direction of parallax in the pieces of light field data.

4. The image capturing apparatus according to claim 1, wherein
the imaging control unit causes acquisition of a smaller number of the pieces of light field data when the direction of phase-difference detection by the focus detection unit corresponds to the direction of parallax in the pieces of light field data than when the direction of phase-difference detection by the focus detection unit does not correspond to the direction of parallax in the pieces of light field data.

5. The image capturing apparatus according to claim 1, wherein
the image capturing unit functions as the focus detection unit.

6. The image capturing apparatus according to claim 1, further comprising
a display unit that displays at least one of a shot image to which refocusing processing based on the pieces of light field data has not been applied, an image, and the refocused image generated by the generation unit.

7. The image capturing apparatus according to claim 6, further comprising
a selection unit that allows a user to select an image that the user thinks is in focus from among a plurality of images displayed on the display unit.

8. The image capturing apparatus according to claim 7, further comprising
a correction unit that corrects a focus position of the image capturing apparatus based on a focus position of the image selected via the selection unit.

9. The image capturing apparatus according to claim 8, further comprising
a storage unit that stores a correction value used by the correction unit.

10. The image capturing apparatus according to claim 6, further comprising:
an image processing unit that applies image processing to at least one of the shot image to which the refocusing processing based on the pieces of light field data has not been applied and the refocused image; and
a control unit that, in a predetermined mode for causing the display unit to display a plurality of images including the shot image and the refocused image and allowing one of the plurality of images to be selected, controls the image processing unit to execute the image processing to reduce a difference between resolutions of the shot image and the refocused image displayed on the display unit.

11. The image capturing apparatus according to claim 1, wherein
the image capturing unit includes an image sensor in which pixels are arranged two-dimensionally, and each pixel includes a plurality of photoelectric converters corresponding to one microlens.

12. A method of controlling an image capturing apparatus including an image capturing unit that photoelectrically converts an object image, the method comprising:
detecting a focus position of an imaging optical system based on a phase-difference detection method using a pair of image signals formed by light that has passed through different pupil areas of the imaging optical system;
controlling the image capturing unit to make the image capturing unit acquire pieces of light field data in one-to-one correspondence with a plurality of focus positions of the imaging optical system that are obtained by shifting the detected focus position of the imaging optical system in increments of a predetermined amount; and
generating a refocused image corresponding to a focus position between the plurality of focus positions of the imaging optical system using the pieces of light field data, the generating depending on a direction of phase-difference detection in the detecting and on a direction of parallax in the pieces of light field data.

13. A computer-readable storage medium having stored therein a program for causing a computer to execute a control method for an image capturing apparatus including an image capturing unit that photoelectrically converts an object image, the control method comprising:
detecting a focus position of an imaging optical system based on a phase-difference detection method using a pair of image signals formed by light that has passed through different pupil areas of the imaging optical system;
controlling the image capturing unit to make the image capturing unit acquire pieces of light field data in one-to-one correspondence with a plurality of focus positions of the imaging optical system that are obtained by shifting the detected focus position of the imaging optical system in increments of a predetermined amount; and
generating a refocused image corresponding to a focus position between the plurality of focus positions of the imaging optical system using the pieces of light field data, the generating depending on a direction of phase-difference detection in the detecting and on a direction of parallax in the pieces of light field data.

14. An image capturing apparatus, comprising:
arm image capturing unit capable of acquiring light field data;
a generation unit that generates a refocused image by applying refocusing processing to the light field data acquired by the image capturing unit;
an image processing unit that applies image processing to at least one of a shot image to which the refocusing processing based on the light field data has not been applied and the refocused image;
a display unit that displays the shot image and the refocused image; and
a control unit that, in a predetermined mode for causing the display unit to display a plurality of images including the shot image and the refocused image and allowing one of the plurality of images to be selected, controls the image processing unit to execute the image processing to reduce a difference between resolutions of the shot image and the refocused image displayed on the display unit.

15. The image capturing apparatus according to claim 14, wherein
the image processing unit applies resolution reduction processing to the shot image.

16. The image capturing apparatus according to claim 15, wherein
the resolution reduction processing is low-pass processing.

17. The image capturing apparatus according to claim 14, wherein
the image processing unit applies resolution enhancement processing to the refocused image.

18. The image capturing apparatus according to claim 17, wherein
the resolution enhancement processing is edge enhancement processing.

19. The image capturing apparatus according to claim 14, further comprising
a selection unit that allows a user to select an image from among the plurality of images displayed on the display unit.

20. The image capturing apparatus according to claim 19, further comprising
a correction unit that corrects a focus position of the image capturing apparatus based on a focus position of the image selected via the selection unit.

21. The image capturing apparatus according to claim 20, further comprising
a storage unit that stores a correction value used by the correction unit.

22. The image capturing apparatus according to claim 14, wherein
the image capturing unit includes an image sensor in which pixels are arranged two-dimensionally, and each pixel includes a plurality of photoelectric converters corresponding to one microlens.

23. A method of controlling an image capturing apparatus including an image capturing unit capable of acquiring light field data, the method comprising:
generating a refocused image by applying refocusing processing to the light field data acquired by the image capturing unit;
applying image processing to at least one of a shot image to which the refocusing processing based on the light field data has not been applied and the refocused image;
displaying the shot image and the refocused image on a display unit; and
in a predetermined mode for causing the display unit to display a plurality of images including the shot image and the refocused image and allowing one of the plurality of images to be selected, controlling the applying of the image processing to reduce a difference between resolutions of the shot image and the refocused image displayed on the display unit.

24. A computer-readable storage medium having stored therein a program for causing a computer to execute a control method for an image capturing apparatus including an image capturing unit capable of acquiring light field data, the control method comprising:
generating a refocused image by applying refocusing processing to the light field data acquired by the image capturing unit;
applying image processing to at least one of a shot image to which the refocusing processing based on the light field data has not been applied and the refocused image;
displaying the shot image and the refocused image on a display unit; and
in a predetermined mode for causing the display unit to display a plurality of images including the shot image and the refocused image and allowing one of the plurality of images to be selected, controlling the image processing to reduce a difference between resolutions of the shot image and the refocused image displayed on the display unit.
